(19) United States
(12) Patent Application Publication
(10) Pub. No.: US 2023/0402639 A1
(43) Pub. Date: Dec. 14, 2023

(54) MULTI-MODULE FUEL CELL POWER GENERATING SYSTEM AND METHOD THEREOF

(71) Applicants: Hyundai Motor Company, Seoul (KR); Kia Corporation, Seoul (KR)

(72) Inventor: Jung Hwan Ryu, Suwon (KR)

(21) Appl. No.: 17/969,467

(22) Filed: Oct. 19, 2022

(30) Foreign Application Priority Data
Jun. 8, 2022 (KR) 10-2022-0069695

(51) Int. Cl. H01M 8/249; H01M 8/04746; H01M 8/04223; H01M 8/04955

(52) U.S. Cl. CPC H01M 8/249; H01M 8/04753; H01M 8/04223; H01M 8/04955

(57) ABSTRACT

The present disclosure relates to startup and cold shutdown (CSD) of a multi-module fuel cell power generating system. According to the present disclosure, a first fuel cell module may supply electric power that is required for startup and cold shutdown of a second fuel cell module, and the second fuel cell module may perform the startup or cold shutdown of the second fuel cell module by using the electric power supplied from the first fuel cell module. According to the present disclosure, the numbers of high-voltage batteries, low-voltage batteries and bi-directional low voltage DC-DC converters (BLDCs) used for multi-module fuel cell power generation may be reduced and control complexity may be reduced.

### CROSS-REFERENCE TO RELATED APPLICATION

This application claims under 35 U.S.C. § 119(a) the benefit of and priority to Korean Patent Application No. 10-2022-0069695, filed in the Korean Intellectual Property Office on Jun. 8, 2022, the entire contents of which are incorporated herein by reference.

### BACKGROUND DESCRIPTION OF THE RELATED ART

In general, a fuel cell system includes a fuel cell stack, in which a plurality of fuel cells used as a power source are stacked, a fuel supply system that supplies hydrogen that is a fuel to the fuel cell stack, an air supply system that supplies oxygen that is an oxidizer that is necessary for an electrochemical reaction, a water/heat management system that controls a temperature of the fuel cell stack, and the like.

### TECHNICAL FIELD

The present disclosure relates to a multi-module fuel cell power generating system and a method thereof, and more particularly, to startup and cold shutdown (CSD) of a multi-module fuel cell power generating system.

In a fuel cell power generating system that requires a high output, a plurality of fuel cell modules (systems) are connected in parallel to each other to increase output. An existing high-output multi-module fuel cell power generating system is constituted by additionally mounting output control boost converters on individual fuel cell modules to control the outputs of the fuel cell modules. Then, a unidirectional insulation type converter is used as the output control converter to secure a total insulation resistance of the power generating system at a safe level when the plurality of fuel cell modules are connected in parallel to each other. An air compressor needs to be driven for startups and cold shutdowns (CSDs) of fuel cells, and an energy source (e.g., a battery) on an output side of a converter cannot be used during the startups and the CSDs due to use of the unidirectional boost converter. Accordingly, the individual fuel cell modules require an additional power supply device for startup. Furthermore, for the CSD, a buck converter for using electric power of a high-voltage battery also is connected whereby a configuration thereof is complex. Accordingly, it is necessary to develop technologies for solving the problem.

### SUMMARY

The present disclosure has been made to address the above-mentioned problems occurring in the related art while advantages achieved by the related art are maintained intact.

An aspect of the present disclosure provides a multi-module fuel cell power generating system, and a method thereof.

Another aspect of the present disclosure provides a multi-module fuel cell power generating system that reduces the number of low-voltage batteries and bi-directional low voltage DC-DC converters (BLDCs) used for multi-module fuel cell power generation and reduces a control complexity, and a method thereof.

Another aspect of the present disclosure provides a multi-module fuel cell power generating system, of which a structure is simplified by excluding use of a high-voltage battery during cold shutdown (CSD).

Another aspect of the present disclosure provides a multi-module fuel cell power generating system that has a small number of configurations and has reduced manufacturing costs, and a method thereof.

Another aspect of the present disclosure provides a multi-module fuel cell power generating system that supplies necessary electric power in a completely independent form by excluding consideration of an external high-voltage battery, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a multi-module fuel cell power generating system includes a first fuel cell module including a first plurality of embedded fuel cells; and a second fuel cell module including a second plurality of embedded fuel cells. In various embodiments, the first fuel cell module is configured to supply electric power required for startup and/or cold shutdown (CSD) of the second fuel cell module. In some embodiments, the second fuel cell module is configured to perform the startup and/or the cold shutdown by using the electric power supplied from the first fuel cell module.

In an embodiment, the first fuel cell module and the second fuel cell module may be electrically connected in parallel to each other and are configured to supply electric power to a grid.

In an embodiment, the first fuel cell module may be electrically connected to a low-voltage battery.

In an embodiment, the first fuel cell module may be electrically connected to the low-voltage battery through a bi-directional low voltage DC-DC converter (BLDC).

In an embodiment, the first fuel cell module may be further configured to perform startup and/or cold shutdown of the first fuel cell module by using electric power generated by the low-voltage battery.

In an embodiment, the first fuel cell module may be further configured to perform startup and/or cold shutdown of the first fuel cell module through driving of an air compressor connected to the first fuel cell module, and the air compressor connected to the first fuel cell module may be driven by using electric power from the low-voltage battery.

In an embodiment, the second fuel cell module may be further configured to perform the startup and/or cold shutdown of the second fuel cell module through driving of an air compressor connected to the second fuel cell module, and the first fuel cell module may supply electric power that is necessary for driving of the air compressor connected to the second fuel cell module.

In an embodiment, the first fuel cell module may deliver electric power required for the startup and/or the cold shutdown to the air compressor connected to the second fuel cell module, via a buck converter or a relay that is switched on when electric power is required for the startup and/or the cold shutdown of the second fuel cell module.

In an embodiment, the first fuel cell module may perform startup of the first fuel cell module by using electric power from the low-voltage battery when startup of the multi-module fuel cell power generating system is required, and the second fuel cell module may perform the startup of the second fuel cell module by using the electric power generated through the first fuel cell module after the startup of the first fuel cell module is finished.

In an embodiment, the second fuel cell module may perform the cold shutdown of the second fuel cell module by using the electric power generated by the first fuel cell module when: (1) it is required to finish an operation of the multi-module fuel cell power generating system and a cold shutdown condition is satisfied, and (2) the first fuel cell module may perform cold shutdown of the first fuel cell module by using electric power generated through the low-voltage battery after the cold shutdown of the second fuel cell module is finished.

In an embodiment, the first fuel cell module and the second fuel cell module may finish startup thereof when it is required to finish the operation of the multi-module fuel cell power generating system and the cold shutdown condition is not satisfied.

In an embodiment, a plurality of first fuel cell modules may be provided, and each first fuel cell module of the plurality of fuel cell modules may be configured to selectively supply electric power required for the startup and/or the cold shutdown by accounting for a break down of the other remaining first fuel cell modules.

According to another aspect of the present disclosure, a method of managing a multi-module fuel cell power generating system includes: providing a first fuel cell module having a first plurality of fuel cells therein and a second fuel cell module having a second plurality of fuel cells therein, supplying, by a first fuel cell module, electric power required for startup or cold shutdown of a second fuel cell module, and performing, by the second fuel cell module, the startup and/or the cold shutdown by using the electric power supplied from the first fuel cell module.

In an embodiment, the method may further include performing startup and/or cold shutdown by using electric power from a low-voltage battery connected to the first fuel cell module, by the first fuel cell module.

In an embodiment, the method may further include driving an air compressor connected to the first fuel cell module by using the electric power from the low-voltage battery, the first fuel cell module may perform startup or cold shutdown of the first fuel cell module by using electric power from the low-voltage battery, and the first fuel cell module may perform the startup or the cold shutdown of the first fuel cell module through driving of an air compressor connected to the first fuel cell module.

In an embodiment, the method may further include supplying, by the first fuel cell module, electric power that is necessary for driving of an air compressor connected to the second fuel cell module, and the performing of the startup and/or the cold shutdown by the second fuel cell module may further include performing, by the second fuel cell module, the startup and/or the cold shutdown of the second fuel cell module through driving of the air compressor connected to the second fuel cell module.

In an embodiment, the supplying, by the first fuel cell module, the electric power that is necessary for driving of the air compressor connected to the second fuel cell module, may include delivering, by the first fuel cell module, electric power required for the startup or the cold shutdown to the air compressor connected to the second fuel cell module, via a buck converter or a relay that is switched on when electric power is required for the startup or the cold shutdown of the second fuel cell module.

In an embodiment, the method may further include performing, by the first fuel cell module, startup of the first fuel cell module by using electric power from a low-voltage battery connected to the first fuel cell module after startup of the multi-module fuel cell power generating system is required, and the performing of the startup or the cold shutdown by using the electric power supplied from the first fuel cell module by the second fuel cell module may include performing, by the second fuel cell module, the startup of the second fuel cell module by using the electric power generated through the first fuel cell module when the startup of the first fuel cell module is finished.

In an embodiment, the method may further include performing cold shutdown of the first fuel cell module by using electric power generated through a low-voltage battery connected to the first fuel cell module after the cold shutdown of the second fuel cell module is finished, and the performing of the startup and/or the cold shutdown by using the electric power supplied from the first fuel cell module by the second fuel cell module may include performing, by the second fuel cell module, the cold shutdown of the second fuel cell module by using the electric power generated through the first fuel cell module when it is required to finish an operation of the multi-module fuel cell power generating system and a cold shutdown condition is satisfied.

In an embodiment, the method may further include finishing, by the first fuel cell module, startup of the first fuel cell module when it is required to finish the operation of the multi-module fuel cell power generating system and the cold shutdown condition is not satisfied, and finishing, by the second fuel cell module, the startup of the second fuel cell module when it is required to finish the operation of the multi-module fuel cell power generating system and the cold shutdown condition is not satisfied.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a multi-module fuel cell power generating system according to an embodiment of the present disclosure;

FIG. 2 is a view illustrating a detailed configuration of an existing multi-module fuel cell power generating system;

FIG. 3 is a view illustrating a detailed configuration of a multi-module fuel cell power generating system according to an embodiment of the present disclosure;

FIG. 4 is a flowchart illustrating a startup process of a multi-module fuel cell power generating system according to an embodiment of the present disclosure;

FIG. 5 is a flowchart illustrating a cold shutdown (CSD) process of a multi-module fuel cell power generating system according to an embodiment of the present disclosure;

FIG. 6 is a block diagram illustrating a multi-module fuel cell power generating system according to another embodiment of the present disclosure; and

FIG. 7 is a flowchart illustrating a method for controlling a multi-module fuel cell power generating system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

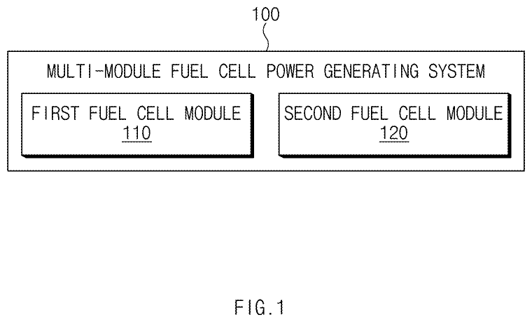

Hereinafter, embodiments of the present disclosure will be described in detail with reference to FIGS. 1 to 7.

FIG. 1 is a block diagram illustrating a multi-module fuel cell power generating system according to an embodiment of the present disclosure.

Referring to FIG. 1, a multi-module fuel cell power generating system 100 may include a first fuel cell module 110 and a second fuel cell module 120.

As an example, the multi-module fuel cell power generating system 100 may be provided in an interior of a vehicle, and may supply electric power to motors and other accessories of the vehicle. However, the multi-module fuel cell power generating system 100 may be implemented to supply electric power to, without being limited to the vehicle, another object that requires electric power.

The first fuel cell module 110 and the second fuel cell module 120 may be connected in parallel to each other to supply electric power to a system.

As an example, the first fuel cell module 110 may be named a master fuel cell module, and the second fuel cell module 120 may be named a slave fuel cell module.

Fuel cells that generate electric power may be embedded in the first fuel cell module 110, and the first fuel cell module 110 may supply electric power required for startup or cold shutdown (CSD) of the second fuel cell module.

Fuel cells that generate electric power may be embedded in the second fuel cell module 120, and the second fuel cell module 120 may perform the startup or cold shutdown (CSD) by using the electric power supplied from the first fuel cell module.

As an example, each of the first fuel cell module 110 and the second fuel cell module 120 may include a fuel cell stack, a hydrogen supply device, an air supply device, and a heat management device.

Furthermore, each of the first fuel cell module 110 and the second fuel cell module 120 may include a controller that controls the module to perform operations, which will be described below.

The controller included in each of the first fuel cell module 110 and the second fuel cell module 120 may include a processor that performs data processing and/or calculations, which will be described below. Furthermore, the controller may include a memory, in which data or algorithms that are necessary in a process of performing data processing and/or calculations are stored.

The processor included in the controller may be an electric circuit that performs instructions of software. For example, the processor included in the controller may be a fuel-cell control unit (FCU), an electronic control unit (ECU), a micro controller unit (MCU), or another lower level controller.

The memory included in the controller may include a memory, such as a flash memory type, a hard disk type, a micro type, or a card type (for example, a secure digital (SD) card or an eXtream digital (XD) card), and a storage medium of at least one of memories, such as a random access memory (RAM), a static RAM (SRAM)), a read-only memory (ROM), a programmable ROM (PROM), an electrically erasable PROM (EEPROM), a magnetic RAM (MRAM), a magnetic disk, and an optical disk.

Furthermore, the controller included in the first fuel cell module 110 and the second fuel cell module 120 may receive control commands from an upper level controller.

The first fuel cell module 110 may be connected to the low-voltage battery.

As an example, the first fuel cell module 110 may be connected to the low-voltage battery through a bi-directional low voltage DC-DC converter (BLDC).

The bi-directional low voltage DC-DC converter may be connected in series to the low-voltage battery, and may control an output of the low-voltage battery.

The first fuel cell module 110 may perform startup or cold shutdown of the first fuel cell module 110 by using electric power generated by the low-voltage battery.

It is necessary to supply external electric power during the startup or cold shutdown of the fuel cell module, and the first fuel cell module 110 may receive external electric power from the low-voltage battery connected thereto.

Because the second fuel cell module 120 may receive the external electric power from the first fuel cell module 110, it may not be connected to the low-voltage battery and the bi-directional low voltage DC-DC converter.

As an example, the first fuel cell module 110 may perform startup of the first fuel cell module 110 by using electric power generated through the low-voltage battery when startup of the multi-module fuel cell power generating system 100 is required.

As an example, the request for the startup of the multi-module fuel cell power generating system 100 may be input through the upper level controller or another controller.

That is, the first fuel cell module 110 may perform startup earlier than the second fuel cell module 120 when the request for the startup of the multi-module fuel cell power generating system 100 is input.

As an example, the second fuel cell module 120 may perform the startup of the second fuel cell module 120 by using the electric power generated through the first fuel cell module 110 when the startup of the first fuel cell module 110 is finished.

For example, for sequential startups of the first fuel cell module 110 and the second fuel cell module 120, a startup finishing signal of the first fuel cell module 110 may be delivered to the second fuel cell module 120.

As another example, the upper controller of the first fuel cell module 110 and the second fuel cell module 120 may manage sequential startups of the first fuel cell module 110 and the second fuel cell module 120.

Unlike the startups, in the case of cold shutdowns, the cold shutdown of the second fuel cell module 120 may be performed earlier than the cold shutdown of the first fuel cell module 110.

As an example, the second fuel cell module 120 may perform the cold shutdown of the second fuel cell module 120 by using the electric power generated through the first fuel cell module 110 when it is required to finish an operation of the multi-module fuel cell power generating system 100 and a cold shutdown condition is satisfied.

As an example, the request for the finishing of the multi-module fuel cell power generating system 100 may be input through the upper level controller or another controller.

Because the second fuel cell module 120 performs the cold shutdown by using the electric power generated through the first fuel cell module 110, it may not receive electric power from an external high-voltage battery.

As an example, the first fuel cell module 110 may perform the cold shutdown of the first fuel cell module 110 by using electric power generated through the low-voltage battery when the cold shutdown of the second fuel cell module 120 is finished.

Because the first fuel cell module 110 performs the cold shutdown by using the electric power generated through the low-voltage battery connected thereto, it may not receive electric power from the external high-voltage battery.

For example, to finish sequential cold shutdown of the first fuel cell module 110 and the second fuel cell module 120, a cold shutdown finishing signal of the second fuel cell module 120 may be delivered to the first fuel cell module 110.

As another example, the upper controller of the first fuel cell module 110 and the second fuel cell module 120 may manage sequential the cold shutdowns of the first fuel cell module 110 and the second fuel cell module 120.

As an example, the first fuel cell module 110 and the second fuel cell module 120 may perform startups or cold shutdowns through air compressors connected to the modules.

During the startups, the air compressors may be used in a process of supplying air to the fuel cell stack.

During the cold shutdowns, the air compressors may be used in a process of removing moisture that resides in the fuel cell stack.

As an example, the air compressor connected to the first fuel cell module 110 may be driven by using the electric power generated through the low-voltage battery.

As an example, the air compressor connected to the second fuel cell module 120 may be driven by using the electric power generated through the first fuel cell module 110.

In this process, the first fuel cell module 110 may supply the electric power that is necessary for driving of the air compressor connected to the second fuel cell module 120.

As an example, the first fuel cell module 110 may deliver the electric power required for the startup or the cold shutdown to the air compressor connected to the second fuel cell module 120, via a buck converter and a relay that is switched on when electric power is required for startup or cold shutdown of the second fuel cell module 120.

As an example, the buck converter may be connected in series to a path, in which the electric power output by the first fuel cell module 110 is delivered to the second fuel cell module 120.

As an example, the buck converter may control reduction of the electric power that is output by the first fuel cell module 110 and is delivered to the second fuel cell module 120.

The first fuel cell module 110 and the second fuel cell module 120 may perform finishing of the startups by themselves when it is required to finish an operation of the multi-module fuel cell power generating system 100 and a cold shutdown condition is not satisfied.

As an example, because it is not necessary to drive the air compressors connected to the fuel cell modules when it is required to finish the operation of the multi-module fuel cell power generating system 100 but the cold shutdown condition is not satisfied, the fuel cell modules may finish the startups by themselves even though electric power is not received from the outside.

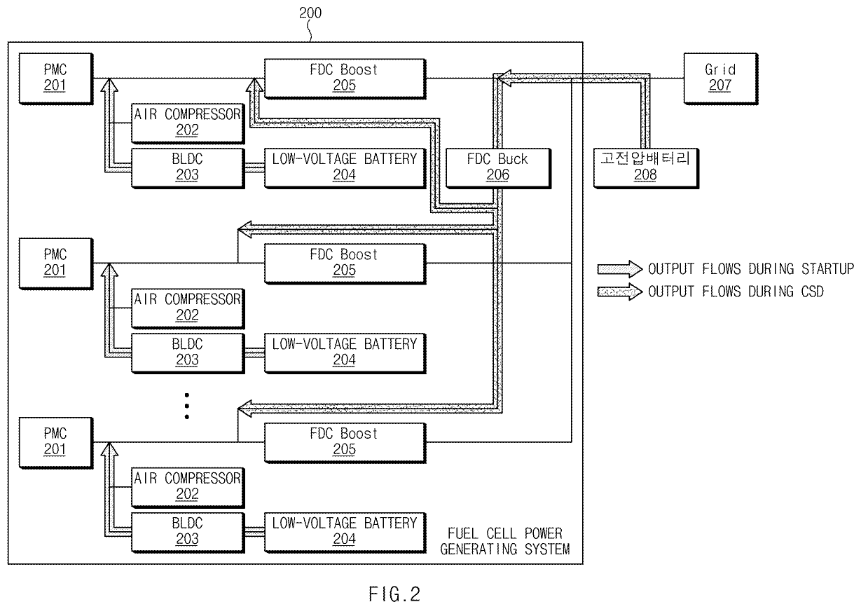

FIG. 2 is a view illustrating a detailed configuration of an existing multi-module fuel cell power generating system.

Referring to FIG. 2, an existing multi-module fuel cell power generating system 200 may include a plurality of fuel cell modules (power module completes (PMCs)) 201.

The plurality of fuel cell modules 201 may be connected in parallel to each other to implement a required high output, and may supply electric power to a grid 207.

Boost converters 205 (a boost converter, a FDC booster, a fuel-cell DC-DC converter booster) connected to the plurality of fuel cell modules 201 may control raising of a voltage of the electric power generated through the plurality of fuel cell modules 201 and may deliver the raised voltage to the grid 207.

To maintain an insulation resistance at a safe level, the boost converter 205 may be implemented by a unidirectional insulation type converter.

The plurality of fuel cell modules 201 may perform startups or cold shutdowns of the fuel cell modules, through driving of air compressors 202.

As an example, the existing fuel cell module 201 may be connected to a low-voltage battery 204 through a bi-directional low voltage DC-DC converter (BLDC).

The electric power generated through the low-voltage battery 204 during the startup of the existing fuel cell module 201 may be controlled through a bi-directional low voltage DC-DC converter 203, and may be delivered to the air compressor 202.

During the startup of the existing fuel cell module 201, the air compressor 202 may be driven through the electric power of the low-voltage battery 204.

A high-voltage battery 208 may be connected to an outside of the existing multi-module fuel cell power generating system 200.

A voltage of the electric power generated through the high-voltage battery 208 may be controlled to be reduced through a buck converter 206 (a buck converter, an FDC buck, a fuel-cell DC-DC converter buck) and the electric power may be delivered to the air compressor 202.

During the cold shutdown of the existing fuel cell module 201, the air compressor 202 may be driven through the electric power of the high-voltage battery 208.

The existing fuel cell power generating system 200 has a complex configuration and a high control complexity for the startup and the cold shutdown of the fuel cell module 201.

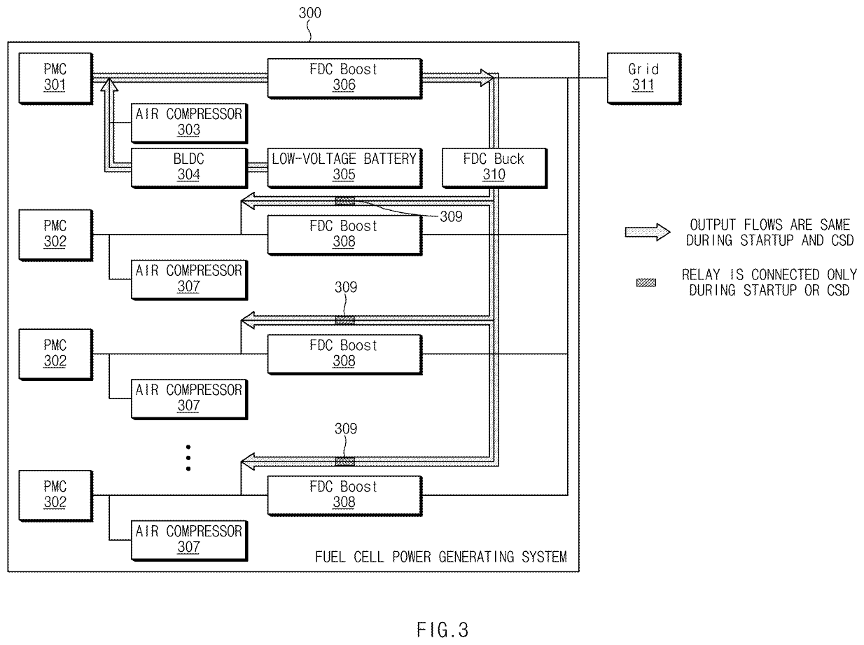

FIG. 3 is a view illustrating a detailed configuration of the multi-module fuel cell power generating system according to an embodiment of the present disclosure.

Referring to FIG. 3, a multi-module fuel cell power generating system 300 may include a first fuel cell module 301 and a second fuel cell module 302.

To implement a required high output, the first fuel cell module 301 and the second fuel cell module 302 may be connected in parallel to each other to supply electric power to a grid 311.

The boost converters 306 and 308 connected to the first fuel cell module 301 and the second fuel cell module 302, respectively, may perform a control to raise a voltage of the electric power generated by the first fuel cell module 301 and the second fuel cell module 302 and may deliver the electric power to the grid 311.

To maintain an insulation resistance at a safe level, the boost converters 306 and 308 may be implemented by a unidirectional insulation type converter.

The first fuel cell module 301 and the second fuel cell module 302 may perform the startups or cold shutdowns of the fuel cell modules, through driving of air compressors 303 and 307 connected thereto.

The first fuel cell module 301 may be connected to a low-voltage battery 305 though a bi-directional low voltage DC-DC converter 304.

The electric power generated through the low-voltage battery 305 during the startup or cold shutdown of the first cell module 301 may be controlled through the bi-directional low voltage DC-DC converter 304, and may be delivered to the air compressor 303.

During the startup or cold shutdown of the first fuel cell module 301, the air compressor 303 connected to the first fuel cell module 301 may be driven through the electric power of the low-voltage battery 305.

In the second fuel cell module 302, the low-voltage battery and the bi-directional low voltage DC-DC converter may not be connected to the second fuel cell module 302.

During the startup or the cold shutdown of the second fuel cell module 302, the electric power generated through the first fuel cell module 301 may be delivered to the air compressor 307 connected to the second fuel cell module 302, through the boost converter 306 and a buck converter 310.

During the startup or cold shutdown of the second fuel cell module 302, the air compressor 307 connected to the second fuel cell module 302 may be driven through the electric power of the first fuel cell module 301.

During the startup or cold shutdown of the second fuel cell module 302, a relay 309 connected to the second fuel cell module 302 may be switched on, and the electric power of the first fuel cell module 301 may be delivered to the air compressor 307.

The fuel cell power generating system 300 according to the present disclosure may not be connected to an external high-voltage battery for the startups or cold shutdowns of the fuel cell modules.

Accordingly, a structure of the fuel cell power generating system may be simplified and a control complexity also may be reduced.

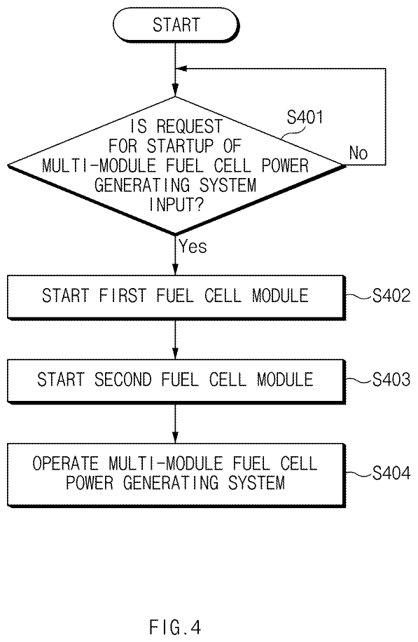

FIG. 4 is a flowchart illustrating a startup process of the multi-module fuel cell power generating system according to an embodiment of the present disclosure.

Referring to FIG. 4, the multi-module fuel cell power generating system may identify whether a request for startup is input (S401).

As an example, the multi-module fuel cell power generating system may identify whether a request for startup is input through the upper level controller or another controller.

When the request for startup is not input, the multi-module fuel cell power generating system may return to S401, and may identify whether a request for startup of the multi-module fuel cell power generating system is input.

When a request for startup of the multi-module fuel cell power generating system is input, the multi-module fuel cell power generating system may perform startup of the first fuel cell module (S402).

As an example, the multi-module fuel cell power generating system may perform the startup of the first fuel cell module by using an output of the low-voltage battery connected to the first fuel cell module.

As an example, the multi-module fuel cell power generating system may perform the startup of the first fuel cell module by driving the air compressor connected to the first fuel cell module through an output of the low-voltage battery.

The multi-module fuel cell power generating system may perform the startup of the second fuel cell module (S403).

As an example, the multi-module fuel cell power generating system may perform the startup of the second fuel cell module by using an output of the first fuel cell module when the startup of the first fuel cell module is finished.

As an example, the multi-module fuel cell power generating system may perform the startup of the second fuel cell module by driving the air compressor connected to the second fuel cell module through an output of the first fuel cell module.

The multi-module fuel cell power generating system may perform the power generation through operations of the first fuel cell module and the second fuel cell module when both of the startups of the first fuel cell module and the second fuel cell module are finished (S404).

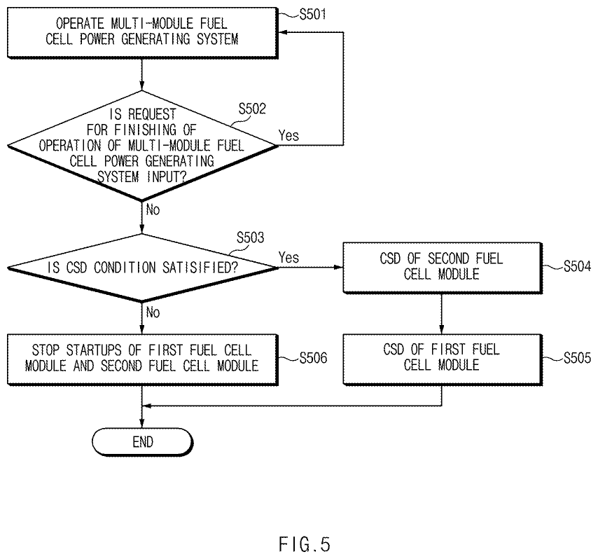

FIG. 5 is a flowchart illustrating a cold shutdown (CSD) process of the multi-module fuel cell power generating system according to an embodiment of the present disclosure.

Referring to FIG. 5, the multi-module fuel cell power generating system 100 may perform operations of the first fuel cell module and the second fuel cell module (S501).

S501 may be the same as S404 illustrated in FIG. 4, and thus may be understood as being continuous to an operation illustrated in FIG. 5 from an operation of FIG. 4.

The multi-module fuel cell power generating system may identify whether a request for finishing is input (S502).

As an example, the multi-module fuel cell power generating system may identify whether a request for finishing of startup is input through the upper level controller or another controller.

When a request for finishing is not input, the multi-module fuel cell power generating system may return to S501, and may perform operations of the first fuel cell module and the second fuel cell module.

When the request for finishing is input, the multi-module fuel cell power generating system may identify whether a cold shutdown (CSD) is satisfied.

As an example, the multi-module fuel cell power generating system may identify whether the cold shutdown condition is satisfied, based on a result obtained by comparing an exterior temperature and a preset reference temperature.

When the cold shutdown condition is satisfied, the multi-module fuel cell power generating system may perform the cold shutdown of the second fuel cell module (S504).

As an example, the multi-module fuel cell power generating system may perform the cold shutdown of the second fuel cell module by using an output of the first fuel cell module.

As an example, the multi-module fuel cell power generating system may perform the cold shutdown of the second fuel cell module by driving the air compressor connected to the second fuel cell module through an output of the first fuel cell module.

The multi-module fuel cell power generating system may perform the cold shutdown of the first fuel cell module (S505).

As an example, the multi-module fuel cell power generating system may perform the cold shutdown of the first fuel cell module by using an output of the low-voltage battery connected to the first fuel cell module when the cold shutdown of the second fuel cell module is finished.

As an example, the multi-module fuel cell power generating system may perform the cold shutdown of the first fuel cell module by driving the air compressor connected to the first fuel cell module through an output of the low-voltage battery.

When the cold shutdown condition is not satisfied, the multi-module fuel cell power generating system may stop startups of the first fuel cell module and the second fuel cell module.

When the request for finishing of the startup is input and the cold shutdown condition is not satisfied, the multi-module fuel cell power generating system does not need to perform the cold shutdown, and thus may stop the startups of the first fuel cell module and the second fuel cell module by itself without receiving electric power.

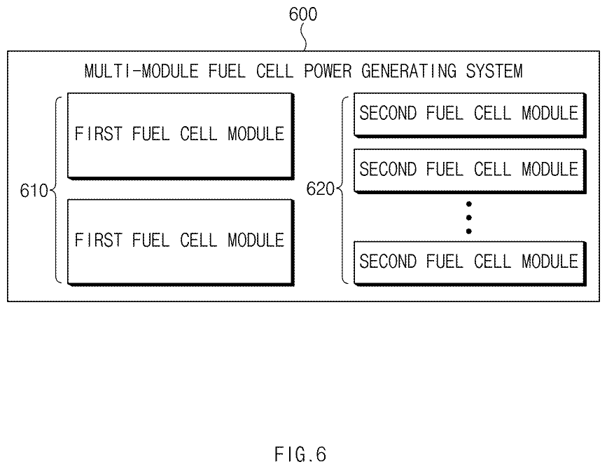

FIG. 6 is a block diagram illustrating a multi-module fuel cell power generating system according to another embodiment of the present disclosure.

Referring to FIG. 6, a multi-module fuel cell power generating system 600 may include two first fuel cell modules 610 and one or more second fuel cell modules 620.

When one of the two first fuel cell modules 610 breaks down, electric power required for startup or cold shutdown of the second fuel cell module may be supplied to the remaining one, which does not break down.

Basically, the two first fuel cell modules 610 and the one or more second fuel cell modules 620 may include all of the features of the first fuel cell module 110 and the second fuel cell module 120, which have been described in FIG. 1.

As an example, when neither of the two first fuel cell modules 610 breaks down, the startups or cold shutdowns of the two first fuel cell modules 610 may be performed through the electric power supplied from the low-voltage batteries connected to the first fuel cell modules, respectively.

Then, through the electric power supplied from the two first fuel cell modules 610, the startups or cold shutdowns of the one or more second fuel cell modules 620 may be performed.

As another example, when neither of the two first fuel cell modules 610 breaks down, among the two first fuel cell modules 610, the fuel cell module having a higher priority may perform the startup or cold shutdown through the electric power supplied from the connected low-voltage battery, and the fuel cell module having a lower priority may perform the startup or cold shutdown through the electric power supplied from the fuel cell module having the higher priority like the second fuel cell module.

Then, the one or more second fuel cell modules 620 may perform the startups or cold shutdowns through the electric power supplied from, among the two first fuel cell modules 610, the fuel cell module having the higher priority.

Although not illustrated, the multi-module fuel cell power generating system 600 may include three or more first fuel cell modules.

In this case, when one or more of the first fuel cell modules provided in the multi-module fuel cell power generating system 600 break down, the startups or cold shutdowns of the one or more second fuel cell modules 620 may be performed through the electric power supplied from the other first fuel cell modules, which do not break down.

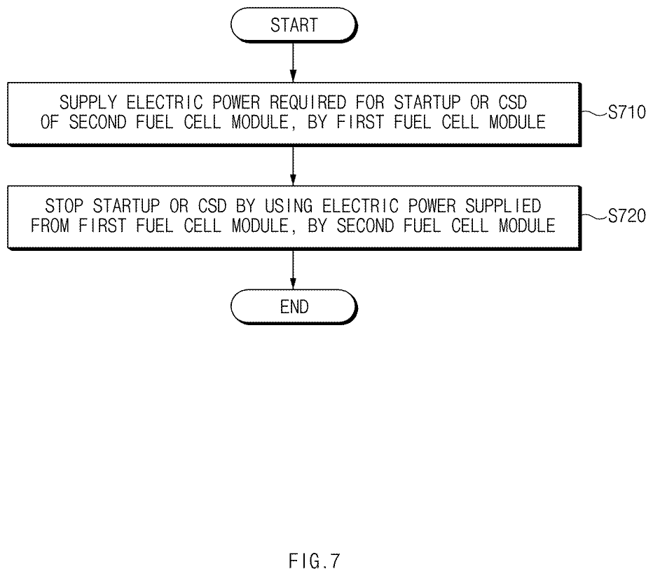

FIG. 7 is a flowchart illustrating a method for controlling a multi-module fuel cell power generating system according to an embodiment of the present disclosure.

Referring to FIG. 7, a method for controlling a multi-module fuel cell power generating system may include an operation (S710) of supplying electric power required for startup or cold shutdown of a second fuel cell module by a first fuel cell module, and an operation (S720) of performing the startup or the cold shutdown by using the electric power supplied from the first fuel cell module by the second fuel cell module.

Although not illustrated, as an example, the method for controlling a multi-module fuel cell power generating system may further include an operation of performing startup or cold shutdown by using electric power generated through a low-voltage battery connected to the first fuel cell module, by the first fuel cell module.

Although not illustrated, as an example, the method for controlling a multi-module fuel cell power generating system may further include an operation of driving an air compressor connected to the first fuel cell module by using the electric power generated through the low-voltage battery.

As an example, the operation of performing the startup or cold shutdown by using the electric power generated through the low-voltage battery connected to the first fuel cell module, by the first fuel cell module may include an operation of performing the startup or cold shutdown of the first fuel cell module through driving of an air compressor connected to the first fuel cell module, by the first fuel cell module.

Although not illustrated, as an example, the method for controlling a multi-module fuel cell power generating system may further include an operation of supplying electric power that is necessary for driving of an air compressor connected to the second fuel cell module, by the first fuel cell module.

As an example, the operation (S720) of performing the startup or cold shutdown by using the electric power supplied from the first fuel cell module, by the second fuel cell module may include an operation of performing the startup or cold shutdown of the second fuel cell module through driving of an air compressor connected to the second fuel cell module, by the second fuel cell module.

As an example, the operation of supplying the electric power that is necessary for the driving of the air compressor connected to the second fuel cell module, by the first fuel cell module, includes an operation of delivering electric power required for the startup or the cold shutdown to the air compressor connected to the second fuel cell module, via a buck converter and a relay that is switched on when electric power is required for startup or cold shutdown of the second fuel cell module, by the first fuel cell module.

Although not illustrated, as an example, the method for controlling a multi-module fuel cell power generating system may further include an operation of performing startup of the first fuel cell module by using electric power generated through the low-voltage battery connected to the low-voltage battery when startup of the multi-module fuel cell power generating system is required, by the first fuel cell module.

As an example, operation (S720) of performing the startup or the cold shutdown of the second fuel cell module by using the electric power supplied from the first fuel cell module by the second fuel cell module may include an operation of performing the startup of the second fuel cell module by using the electric power generated through the first fuel cell module by the second fuel cell module when the startup of the first fuel cell module is finished.

Although not illustrated, as an example, the method for controlling a multi-module fuel cell power generating system may further include an operation of performing cold shutdown of the first fuel cell module by using electric power generated through the low-voltage battery connected to the first fuel module when the cold shutdown of the second fuel cell module is finished.

As an example, operation (S720) of performing the startup or the cold shutdown of the second fuel cell module by using the electric power supplied from the first fuel cell module by the second fuel cell module may include an operation of performing the cold shutdown of the second fuel cell module by using the electric power generated through the first fuel cell module when it is required to finish an operation of the multi-module fuel cell power generating system and a cold shutdown condition is satisfied, by the second fuel cell module.

Although not illustrated, as an example, the method for controlling a multi-module fuel cell power generating system may further include an operation of finishing startup of the first fuel cell module when it is required to finish the operation of the multi-module fuel cell power generating system and the cold shutdown condition is not satisfied, by the first fuel cell module, and an operation of finishing startup of the second fuel cell module when it is required to finish the operation of the multi-module fuel cell power generating system and the cold shutdown condition is not satisfied, by the second fuel cell module.

Accordingly, the steps of the method or algorithm described in relation to the embodiments of the present disclosure may be implemented directly by hardware executed by the processor, a software module, or a combination thereof. The software module may reside in a storage medium (that is, the memory and/or the storage), such as a RAM, a flash memory, a ROM, an EPROM, an EEPROM, a register, a hard disk, a detachable disk, or a CD-ROM.

The exemplary storage medium is coupled to the processor, and the processor may read information from the storage medium and may write information in the storage medium. In another method, the storage medium may be integrated with the processor. The processor and the storage medium may reside in an application specific integrated circuit (ASIC). The ASIC may reside in a user terminal. In another method, the processor and the storage medium may reside in the user terminal as an individual component.

Effects of the multi-module fuel cell power generating system and the method thereof according to the present disclosure will be described as follows.

At least one of the embodiments of the present disclosure may provide a multi-module fuel cell power generating system that reduces the number of low-voltage batteries and bi-directional low voltage DC-DC converters (BLDCs) used for multi-module fuel cell power generation and reduces a control complexity, and a method thereof.

Furthermore, at least one of the embodiments of the present disclosure may provide a multi-module fuel cell power generating system, of which a structure is simplified by excluding use of a high-voltage battery during cold shutdown (CSD).

Furthermore, at least one of the embodiments of the present disclosure may provide a multi-module fuel cell power generating system that has a small number of configurations and has reduced manufacturing costs, and a method thereof.

Furthermore, at least one of the embodiments of the present disclosure may provide a multi-module fuel cell power generating system that supplies necessary electric power in a completely independent form by excluding consideration of an external high-voltage battery, and a method thereof.

In addition, the present disclosure may provide various effects that are directly or indirectly recognized.

The above description is a simple exemplification of the technical spirits of the present disclosure, and the present disclosure may be variously corrected and modified by those skilled in the art to which the present disclosure pertains without departing from the essential features of the present disclosure.

Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

What is claimed is:

1. A multi-module fuel cell power generating system, comprising:
a first fuel cell module including a first plurality of embedded fuel cells; and
a second fuel cell module including a second plurality of embedded fuel cells,
wherein the first fuel cell module is configured to supply electric power required for startup and/or cold shutdown (CSD) of the second fuel cell module, and
wherein the second fuel cell module is configured to perform the startup and/or the cold shutdown by using the electric power supplied from the first fuel cell module.

2. The multi-module fuel cell power generating system of claim 1, wherein the first fuel cell module and the second fuel cell module are electrically connected in parallel to each other and are configured to supply electric power to a grid.

3. The multi-module fuel cell power generating system of claim 1, wherein the first fuel cell module is electrically connected to a low-voltage battery.

4. The multi-module fuel cell power generating system of claim 3, wherein the first fuel cell module is electrically connected to the low-voltage battery through a bi-directional low voltage DC-DC converter (BLDC).

5. The multi-module fuel cell power generating system of claim 3, wherein the first fuel cell module is further configured to perform startup and/or cold shutdown of the first fuel cell module by using electric power generated by the low-voltage battery.

6. The multi-module fuel cell power generating system of claim 3, wherein the first fuel cell module is further configured to perform startup and/or cold shutdown of the first fuel cell module through driving of an air compressor connected to the first fuel cell module, and
wherein the air compressor connected to the first fuel cell module is driven by electric power from the low-voltage battery.

7. The multi-module fuel cell power generating system of claim 1, wherein the second fuel cell module is further configured to perform the startup and/or cold shutdown of the second fuel cell module through driving of an air compressor connected to the second fuel cell module, and
wherein the first fuel cell module supplies electric power that is necessary for driving of the air compressor connected to the second fuel cell module.

8. The multi-module fuel cell power generating system of claim 7, wherein the first fuel cell module delivers electric power required for the startup and/or the cold shutdown to the air compressor connected to the second fuel cell module, via a buck converter and a relay that is switched on when electric power is required for the startup and/or the cold shutdown of the second fuel cell module.

9. The multi-module fuel cell power generating system of claim 3, wherein the first fuel cell module performs startup of the first fuel cell module by using electric power from the low-voltage battery when startup of the multi-module fuel cell power generating system is required, and
wherein the second fuel cell module performs the startup of the second fuel cell module by using the electric power generated by the first fuel cell module after the startup of the first fuel cell module is finished.

10. The multi-module fuel cell power generating system of claim 3, wherein the second fuel cell module performs the cold shutdown of the second fuel cell module by using the electric power generated by the first fuel cell module when: (1) it is required to finish an operation of the multi-module fuel cell power generating system and (2) a cold shutdown condition is satisfied, and
wherein the first fuel cell module performs cold shutdown of the first fuel cell module by using electric power from the low-voltage battery after the cold shutdown of the second fuel cell module is finished.

11. The multi-module fuel cell power generating system of claim 10, wherein the first fuel cell module and the second fuel cell module each finish startup thereof when it is required to finish the operation of the multi-module fuel cell power generating system and the cold shutdown condition is not satisfied.

12. The multi-module fuel cell power generating system of claim 1, further comprising a plurality of first fuel cell modules, and
wherein each first fuel cell module of the plurality of first fuel cell modules is configured to selectively supply electric power required for the startup and/or the cold shutdown via any by accounting for a break down of the other remaining first fuel cell modules.

13. A method of managing a multi-module fuel cell power generating system, the method comprising:
providing a first fuel cell module having a first plurality of fuel cells therein and a second fuel cell module having a second plurality of fuel cells therein;
supplying, by the first fuel cell module, electric power required for startup and/or cold shutdown of the second fuel cell module; and
performing, by the second fuel cell module, the startup and/or the cold shutdown by using the electric power supplied from the first fuel cell module.

14. The method of claim 13, further comprising:
performing, by the first fuel cell module, startup or cold shutdown by using electric power from a low-voltage battery connected to the first fuel cell module.

15. The method of claim 14, further comprising:
driving an air compressor connected to the first fuel cell module by using the electric power from the low-voltage battery,
wherein the first fuel cell module performs startup or cold shutdown of the first fuel cell module by using electric power from the low-voltage battery, and
wherein the first fuel cell module performs the startup or the cold shutdown of the first fuel cell module through driving of an air compressor connected to the first fuel cell module.

16. The method of claim 13, further comprising:
supplying, by the first fuel cell module, electric power that is necessary for driving of an air compressor connected to the second fuel cell module,
wherein the performing of the startup and/or the cold shutdown by the second fuel cell module step further includes:
performing, by the second fuel cell module, the startup and/or the cold shutdown of the second fuel cell module through driving of the air compressor connected to the second fuel cell module.

17. The method of claim 16, wherein the supplying, by the first fuel cell module, the electric power that is necessary for driving of the air compressor connected to the second fuel cell module step further includes:
delivering, by the first fuel cell module, electric power required for the startup or the cold shutdown to the air compressor connected to the second fuel cell module, via a buck converter and a relay that is switched on when electric power is required for the startup and/or cold shutdown of the second fuel cell module.

18. The method of claim 13, further comprising:
performing, by the first fuel cell module, startup of the first fuel cell module by using electric power from a low-voltage battery connected to the first fuel cell module after startup of the multi-module fuel cell power generating system is required, and
wherein the performing of the startup and/or the cold shutdown by using the electric power supplied from the first fuel cell module by the second fuel cell module step further includes:
performing, by the second fuel cell module, the startup of the second fuel cell module by using the electric power generated through the first fuel cell module after the startup of the first fuel cell module is finished.

19. The method of claim 13, further comprising:
performing cold shutdown of the first fuel cell module by using electric power generated through a low-voltage battery connected to the first fuel cell module after the cold shutdown of the second fuel cell module is finished,
wherein the performing of the startup and/or the cold shutdown by using the electric power supplied from the first fuel cell module by the second fuel cell module includes:
performing, by the second fuel cell module, the cold shutdown of the second fuel cell module by using the electric power generated through the first fuel cell module when it is required to finish an operation of the multi-module fuel cell power generating system and a cold shutdown condition is satisfied.

20. The method of claim 19, further comprising:
finishing, by the first fuel cell module, startup of the first fuel cell module when it is required to finish the operation of the multi-module fuel cell power generating system and the cold shutdown condition is not satisfied; and
finishing, by the second fuel cell module, the startup of the second fuel cell module when it is required to finish the operation of the multi-module fuel cell power generating system and the cold shutdown condition is not satisfied.
